(19) United States
(12) Patent Application Publication
(10) Pub. No.: US 2026/0297702 A1
(43) Pub. Date: Oct. 1, 2026

(54) TEMPERATURE-CONTROL DEVICE

(71) Applicant: EBNER Industrieofenbau GmbH, Leonding (AT)

(72) Inventors: Robert EBNER, Leonding (AT); Albert NEUMÜLLER, Leonding (AT); Markus KÖCK, Leonding (AT)

(73) Assignee: EBNER Industrieofenbau GmbH, Leonding (AT)

(21) Appl. No.: 19/477,175

(22) PCT Filed: Apr. 22, 2024
(86) PCT No.: PCT/AT2024/060164

§ 371 Date: Oct. 21, 2025

(30) Foreign Application Priority Data
Apr. 24, 2023 (AT) A50304/2023

(51) Int. Cl. C21D 11/00; C21D 1/18; C21D 9/00; F27B 9/36; F27D 7/02; F27D 19/00

(52) U.S. Cl. CPC C21D 11/005; C21D 1/18; C21D 9/0062; F27B 9/36; F27D 7/02; F27D 19/00; C21D 2211/002; C21D 2211/008; F27B 2009/3638; F27D 2019/0003; F27D 2019/0053

(57) ABSTRACT

A temperature-control device for controlling the temperature of a component, which is transported through the device in a conveying direction along at least one conveying plane, includes a first arrangement of first discharge elements for supplying a first, in particular gaseous, temperature-control medium to the component, and at least one other arrangement of other discharge elements for supplying at least one other, in particular gaseous, temperature-control medium to the component downstream of the first arrangement of first discharge elements in the conveying direction.

The invention relates to a temperature-control device for controlling the temperature of a component, which is transported through the device in a conveying direction along at least one conveying plane, the temperature-control device comprising a first arrangement of first discharge elements for supplying a first, in particular gaseous, temperature-control medium to the component.

The invention further relates to a plant for adjusting a microstructure or a microstructure distribution in a metal component comprising a furnace for heating the metal component to a first temperature and a temperature-control device for controlling the temperature of the component to at least one second temperature, which is lower than the first temperature.

In addition, the invention relates to a method for adjusting a microstructure or a microstructure distribution in a metal component comprising the steps: heating the component to a first temperature in a furnace, cooling down the heated component to a second temperature, which is lower than said first temperature, in a temperature-control device, to which end a first temperature-control fluid, which is discharged from first discharge elements, is applied to the component in the temperature-control device.

In modern metal processing, in particular in case of metal materials for body parts in automobile manufacture, there is a demand for components having precisely-adjusted ductility and brittleness properties. The adjustment of a metal component with regions of different ductility is in particular enabled by a precise adjustment of the temperature curves during the quenching and tempering and/or manufacture of the components, which can be used to adjust the desired microstructure grades of a component in predefined regions. Especially in longer conveyor furnaces, a precise temperature-control profile of the component to be manufactured inside conveyor furnaces is complex and difficult due to the dynamic movement of the component during its manufacture.

To manufacture such a component, WO 2018/103841 A1 proposes a device for controlling temperature, having a temperature-control zone, along which the component is movable along a conveying direction, wherein the temperature-control zone is configured to control the temperature of at least one temperature-control region of the component. The device has a temperature-control zone controller, which is configured for covering a cover region of the temperature-control zone such that, in the cover region, a temperature-control effect of the temperature-control zone can be reduced to the temperature-control region of the component, wherein the temperature-control zone controller is configured for adjusting the size of the cover region.

Generally, this device has proven successful in practice, but even this device is limited in terms of the formation of microstructure.

The object underlying the present invention is to create a possibility for forming different microstructures with one plant.

The object of the invention is achieved by the temperature-control device mentioned in the beginning, in which it is provided that at least one other arrangement of other discharge elements for supplying at least one other, in particular gaseous, temperature-control medium to the component is arranged downstream of the first arrangement of first discharge elements in the conveying direction.

The object is further achieved by the plant mentioned in the beginning, in which the temperature-control device is configured according to the invention.

In addition, the object of the invention is achieved by the method mentioned in the beginning, according to which it is provided that, after the treatment with the first temperature-control fluid, another temperature-control fluid, which is discharged from other discharge elements, is applied to the component in the temperature-control device.

It is of advantage here that, due to being distributed over multiple arrangements, the discharge elements can be operated independently of each other. This enables the number of temperature-control variants to be increased, whereby the spectrum of manufacturable components, i.e. different microstructure formations, can be broadened with only one temperature-control device. For example, the temperature-control device enables a rapid quenching with a subsequent homogenizing and then a finishing cooling at different temperatures. This enables different technologies and different methods, for which multiple plants were previously used, to be realized with one plant and/or with one temperature-control device.

According to an embodiment variant of the invention, it may be provided that some of the first discharge elements are arranged above the conveying plane and others of the first discharge elements are arranged below the conveying plane. This embodiment variant enables a more even formation of microstructure in a shorter time. In addition, the temperature-control medium and/or temperature-control media may optionally contribute to the conveyance of the component through the temperature-control device.

For the same reason and according to another embodiment variant of the invention, some of the other discharge elements may also be arranged above the conveying plane and others of the other discharge elements below the conveying plane.

According to another embodiment variant of the invention, it may be provided that the first and/or other discharge elements are controllable, individually or in groups, in an open loop and/or in a closed loop by an open-loop and/or closed-loop control device, whereby the variability of the execution of the method can be increased further.

It may be provided here according to an embodiment variant of the invention that the open-loop and/or closed-loop control device is configured for controlling, in an open loop or in a closed loop, at least one of the following parameters for supplying the first temperature-control fluid to the first discharge elements and/or the other temperature-control fluid to the other discharge elements: the volume flow of the first temperature-control fluid and/or of the other temperature-control fluid; the composition of the first temperature-control fluid and/or of the other temperature-control fluid; a first distance of the first discharge elements to the conveying plane and/or another distance of the other discharge elements to the conveying plane; the number of active first discharge elements and/or active other discharge elements. The open-loop and/or closed-loop control of these parameters enables the process reliability to be improved, as these parameters are relatively simple to model in terms of open-loop and/or closed-loop control.

According to another embodiment variant of the invention, it may be provided that at least one receiving opening of a first receiving device for receiving the first temperature-control fluid is arranged in the region of the first discharge elements for the first temperature-control fluid. This achieves a controlled, in particular targeted, removal of the first temperature-control fluid from the component, whereby the precision of the microstructure adjustment can be improved.

According to an embodiment variant of the invention, multiple first receiving openings may be arranged between the first discharge elements to further enhance these effects.

According to an embodiment variant of the invention, the removed first temperature-control medium can be supplied to a heat exchanger, so that at least some of the received process heat can be utilized elsewhere. To that end, the first receiving device can be flow-connected to at least one first heat exchanger.

This latter execution of the process has the additional advantage that, according to an embodiment variant of the invention, the first discharge elements, the first receiving device and the first heat exchanger can be arranged in a first temperature-control fluid circuit, whereby the negative environmental impact of the temperature-control device can be reduced by (considerably) reducing the consumption of first temperature-control fluid.

For the reasons mentioned, it may be provided according to another embodiment variant of the invention that at least one receiving opening of another receiving device for receiving the other temperature-control fluid is arranged in the region of the other discharge elements for the other temperature-control fluid and/or that multiple second receiving openings are arranged between the second discharge elements, and/or that the other receiving device is flow-connected to at least one other heat exchanger, and/or that the other discharge elements, the other receiving device and the other heat exchanger are arranged in another temperature-control fluid circuit.

According to another embodiment variant of the invention, it may be provided that a heating device for heating at least some of the other temperature-control fluid is arranged upstream of the other discharge elements in a flow direction of the other temperature-control fluid. This achieves a further increase of the number of different executions of the process with the temperature-control device, for example in that, after the first cool-down of the component, the component can be heated again in a targeted manner (in regions).

A further increase of the number of different executions of the process is also achievable with an embodiment variant of the invention, according to which the first discharge elements are distributed over multiple first segments, wherein each of the first segments respectively has a separate supply for the first temperature-control fluid and/or that the other discharge elements are distributed over multiple other segments, wherein each of the other segments respectively has a separate supply for the other temperature-control fluid.

According to another embodiment variant of the invention, it may be provided that, after the cooling down of the component with the first temperature-control fluid, an increase of the temperature of the component is executed with the other temperature-control fluid. This enables a more uniform heating of the component with the other temperature-control fluid. In addition, this enables also waste heat from the process itself to be used, for example by heating the other temperature-control fluid using a heat exchanger, to which end the heat exchanger may be supplied a fluid from the or another process.

According to other embodiment variants of the invention, it may be provided that the component is heated to austenitizing temperature as a first temperature in a furnace for at least 2 seconds and is subsequently quenched to 280° C.-200° C. with at least 50 K/s for forming a martensitic microstructure and preferably subsequently homogenized and finishing cooled, or is quenched to 450° C.-380° C. with at least 50 K/s for forming a bainitic microstructure and is preferably subsequently homogenized in a time between 30 seconds to 90 seconds and maintained at the temperature, or is quenched to 550° C.-480° C. with at least 50 K/s for forming a sorbitic microstructure and is preferably subsequently homogenized in a time between 5 seconds to 10 seconds, maintained at the temperature, reheated and finishing cooled, or is quenched to 290° C.-200° C. with at least 20 K/s for forming a martensitic microstructure in a chromic steel and is preferably subsequently homogenized and finishing cooled, or is cooled down to the second temperature with a cool-down speed of maximally 30 K/s, in particular maximally 25 K/s, for normalizing.

According to another embodiment variant of the invention, it may be provided that the component is brought from the furnace directly into the temperature-control device, to which end the temperature-control device may be arranged so as to immediately adjoin the furnace. Among other things, this enables the quenching of the component from the first to the second temperature in a more controlled manner, so that the properties of the component can be improved.

It is also of advantage according to another embodiment variant of the invention if a gaseous or vaporous fluid, in particular hydrogen or nitrogen or a mixture thereof, is used as the first temperature-control fluid and/or as the other temperature-control fluid. This achieves an improved heat conductivity between the component and the first temperature-control fluid and/or the other temperature-control fluid.

According to another embodiment variant of the invention, it may be provided that a fluid that is different from the first temperature-control fluid, in particular has a different thermal capacity, is used as the other temperature-control fluid, which enables a better influence on the temperature control of the component and/or on the entire temperature-control process that the component undergoes in the temperature-control device.

To further increase the number of different methodologies and to increase the variability of the usability of the plant, it may also be provided according to an embodiment variant that the component is moved through between first discharge elements and/or between other discharge elements, so that the first temperature-control fluid and/or the other temperature-control fluid are applied to the component bilaterally.

For the purpose of better understanding of the invention, it will be elucidated in more detail by means of the figures below.

These show in a simplified schematic representation:

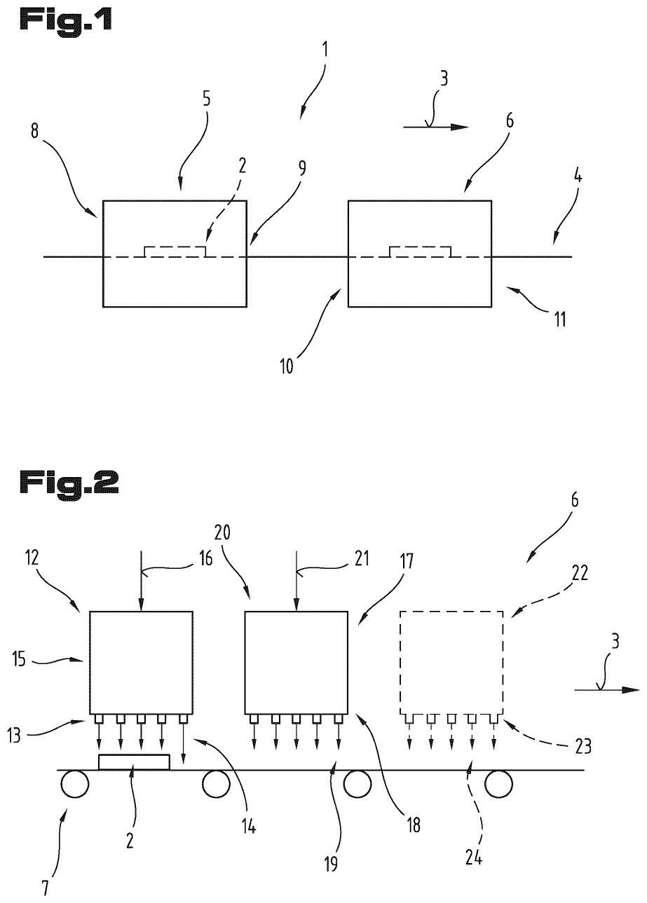

FIG. 1 a detail from a plant for adjusting a microstructure or a microstructure distribution in a metal component;

FIG. 2 a first embodiment variant of a temperature-control device;

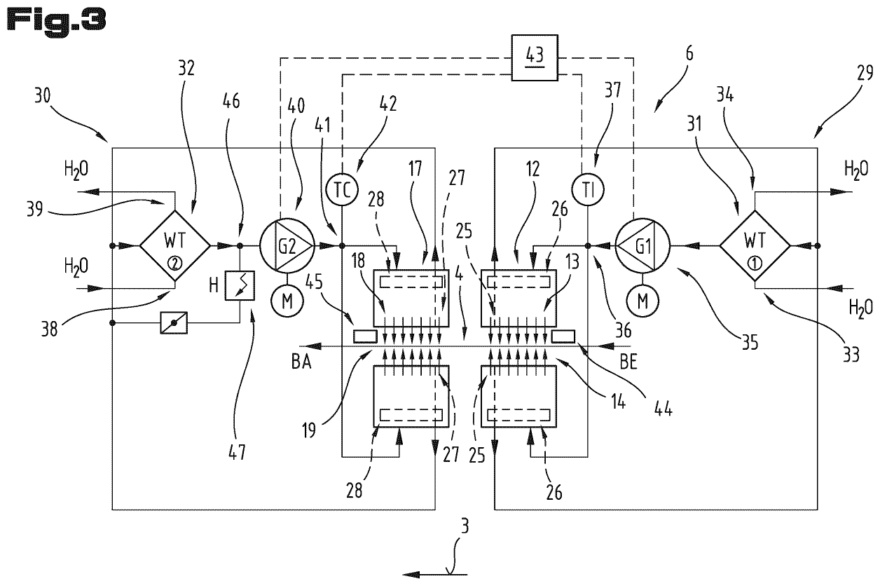

FIG. 3 a second embodiment variant of a temperature-control device;

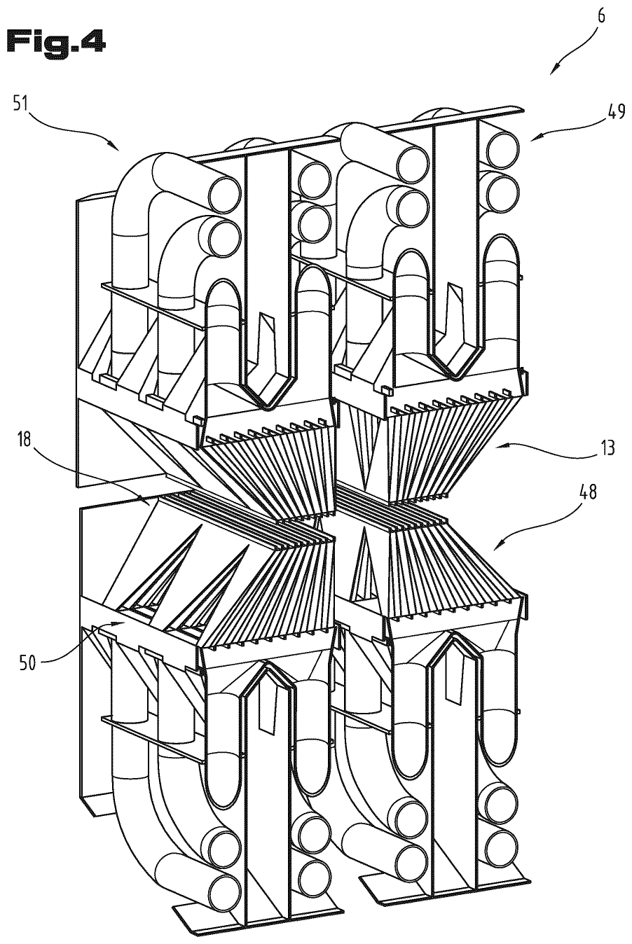

FIG. 4 a detail from another embodiment variant of a temperature-control device.

First of all, it is to be noted that, in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure, and in case of a change of position, these specifications of location are to be analogously transferred to the new position.

FIG. 1 shows a detail from a plant 1 for adjusting a microstructure or a microstructure distribution in a component 2.

The component 2 is in particular a metal component 2. The component 2 may represent a piece of sheet metal, for example. The component 2 may represent a preformed piece of metal, for example. In a preferred embodiment, the component 2 is a strip, in particular a metal strip, which passes through the plant 1 along a conveying direction 3 in at least one conveying plane 4.

Generally, also non-metal components 2 can be heat-treated in the plant 1, even though this is not the preferred embodiment variant.

Further, the component 2 is transported through the plant 1 preferably in a single conveying plane 4. Yet, it is possible for the component 2 to be transported through the plant 1 on multiple different planes. Optionally, in addition to a horizontal transport also a vertical transport can be provided in a section of the plant 1.

The plant 1 comprises a furnace 5 and a temperature-control device 6. The temperature-control device 6 is arranged downstream of the furnace in the conveying direction 3. Preferably, there is no other device between the furnace 5 and the temperature-control device 6, so that the component 2 can therefore be brought from the furnace 5 directly into the temperature-control device 6. The temperature-control device 6 may optionally also immediately adjoin the furnace 5.

Evidently, the plant 1 may have other components, which may be configured according to the prior art pertaining to such plants 1, however. For example, the plant 1 may have a conveying device 7, as indicated in FIG. 2. The conveying device may be a roller conveyor, a chain conveyor, a band conveyor, an overhead band conveyor, etc., for example. For more details on this and/or on other components of the plant 1, reference is made to the relevant prior art.

It should be noted in this context that a method for adjusting a microstructure or a microstructure distribution in the component 2 is executable with the plant 1 and/or methods for controlling the temperature of the component 2 are executable in the temperature-control device 6. Whenever only the plant 1 and/or the temperature-control device 6 as such are mentioned below, the methods executable with the plant 1 and/or the temperature-control device 6 are therefore addressed, so that the invention can be formulated also as a method, optionally using the description below.

In the furnace 5, the component 2 is heated to a first temperature. The furnace 6 may be a furnace that is used in hardening and/or quenching-and-tempering lines and in CALs (continuous annealing lines). For example, the furnace 5 may be a so-called austenitizing furnace if a steel part is processed as the component 2, wherein the steel part is heated to and/or above austenitizing temperature in the furnace 5.

Preferably, the furnace 5 is a continuously operated furnace 5 (conveyor furnace) with a furnace inlet 8 at the start of the furnace 5 and a furnace outlet 9, which is configured at the other end of the furnace 5 in a conveying direction 3, so that the component 2 can therefore be moved through the furnace 5 at a (continuous) speed.

Also the temperature-control device 6 is preferably operated continuously, to which end it has a device inlet 10 and a device outlet 11, which is configured at the other end of the temperature-control device 6 in a conveying direction 3, so that the component 2 can therefore be moved through the temperature-control device 6 at a (continuous) speed.

However, the furnace 5 and/or the temperature-control device 6 may also be operated discontinuously, even though this is not the preferred embodiment variant of the invention.

In the temperature-control device 6, the component 2 is cooled down to a second temperature, which is lower than said first temperature.

FIG. 2 shows a first embodiment variant of the temperature-control device 6 for controlling the temperature of the component 2. Here, the component 2 is lying on the conveying device 7. As explained above, the specific representation of this conveying device 7 must not be understood to be limiting. The component 2 may also be conveyed through the temperature-control device 6 contactless at least in sections or entirely, for example with an overhead band device.

The temperature-control device 6 has a first arrangement 12 of first discharge elements 13 for supplying a first temperature-control fluid 14 to/onto the component 2.

The first arrangement 12 may have a housing 15, at/in which the first discharge elements 13 are arranged. The housing 15 may have one or multiple supply device(s) 16 for the first temperature-control fluid 14, for example a pipe. Inside the housing 15, the temperature-control fluid 14 may be distributed over the individual discharge elements 13. Yet, it is also possible to provide a distribution device, in which the supply device 16 ends and from which lines lead to the discharge elements 13, in which the first temperature-control fluid 14 is supplied to the discharge elements 13. Optionally, the first arrangement 12 may be configured without a housing.

The first discharge elements 13 may be configured nozzle-like and/or as nozzles. For example, the first discharge elements 13 may be configured as round nozzles, as slotted nozzles, etc. The first discharge elements 13 may have a circular, oval, rectangular, square, polygonal, etc., exit opening at least at the exit of the first temperature-control fluid 14.

The first discharge elements 13 may extend continuously over a total width of the temperature-control device 6 and/or of the conveying device 7 and/or of the component 2 (in FIG. 2 in a perpendicular direction to the paper plane). Yet, it is also possible that multiple individual first discharge elements 13 are arranged next to each other, viewed along the width.

In the conveying direction 3, multiple first discharge elements 13 are arranged successively and at a distance to each other. Here, the precise number of the first discharge elements 13 in a conveying direction 3 and the distance between the first discharge elements 13 depends on the plant design.

The arrangement of first discharge elements 13 may therefore also be referred to as a first nozzle array. The first arrangement 12 may therefore also be referred to as a first nozzle box.

The first temperature-control fluid 14 is in particular gaseous. Yet, it may also be liquid or vaporous. For example, the first temperature-control fluid 14 may have or be air or preferably protective gas or an inert gas. The first temperature-control fluid 14 may further have a predetermined temperature. The first temperature-control fluid 14 may be water, an oil-containing liquid, water vapor or another vaporous element, for example. In the preferred embodiment variant, the first temperature-control fluid 14 may have hydrogen or nitrogen or be a mixture thereof.

Downstream of the first arrangement 12 of first discharge elements 13 in the conveying direction 3, at least one other arrangement 17 of other discharge elements 18 for supplying at least one other, in particular gaseous, temperature-control fluid 19 to the component 2 is arranged. The other arrangement 17 of other discharge elements 18 is arranged preferably immediately downstream of and optionally at a distance to the first arrangement 12 of first discharge elements 13 in the conveying direction 3. Preferably, the component 2 is therefore conveyed from the first arrangement 12 directly into the other arrangement 17, as can be seen from the figures.

The other arrangement 17 may have another housing 20, at/in which the other discharge elements 18 are arranged. The other housing 20 may have one or multiple other supply device(s) 21 for the other temperature-control fluid 19, for example a pipe. Inside the other housing 20, the other temperature-control fluid 19 may be distributed over the individual other discharge elements 18. Yet, it is also possible to provide a distribution device, in which the other supply device 21 ends and from which lines lead to the other discharge elements 18, in which the other temperature-control fluid 19 is supplied to the other discharge elements 18. Optionally, the other arrangement 17 may be configured without a housing.

The other discharge elements 18 may be configured nozzle-like and/or as nozzles. For example, they may be configured as round nozzles, as slotted nozzles, etc. The other discharge elements 18 may have a circular, oval, rectangular, square, polygonal, etc., exit opening at least at the exit of the other temperature-control fluid 19.

The other discharge elements 18 may extend continuously over a total width of the temperature-control device 6 and/or of the conveying device 7 and/or of the component 2 (in FIG. 2 in a perpendicular direction to the paper plane). Yet, it is also possible that multiple individual other discharge elements 18 are arranged next to each other, viewed along the width.

In the conveying direction 3, multiple other discharge elements 18 are arranged successively and at a distance to each other. Here, the precise number of the other discharge elements 18 in the conveying direction 3 and the distance between the other discharge elements 18 depends on the plant design.

The arrangement of other discharge elements 18 may therefore also be referred to as another nozzle array. The other arrangement 17 may therefore also be referred to as another nozzle box.

The other temperature-control fluid 19 is in particular gaseous. Yet, it may also be liquid or vaporous. For example, the other temperature-control fluid 19 may have or be air or preferably protective gas or an inert gas. The other temperature-control fluid 19 may further have a predetermined temperature. The other temperature-control fluid 19 may be water, an oil-containing liquid, water vapor or another vaporous element, for example. In the preferred embodiment variant, the other temperature-control fluid 19 may have hydrogen or nitrogen or be a mixture thereof.

The other temperature-control fluid 19 is preferably different from the first temperature-control fluid 14. This difference may be in the kind and/or in the composition and/or in the temperature of the temperature-control fluids 14, 19.

In the preferred embodiment variant of the temperature-control device 6, the first arrangement 12 and the other arrangement 17 each have separate, independent supplies with the first temperature-control fluid 14 and/or the other temperature-control fluid 19. It is also possible that the first arrangement 12 and the other arrangement 17 have a joint supply of some of the first temperature-control fluid 14 and/or of the other temperature-control fluid 19. In this embodiment variant of the temperature-control device 6, the remaining part of the first temperature-control fluid 14 and/or of the other temperature-control fluid 19 is then formed by a separate supply. To that end, the first supply device 16 or the other supply device 21 may be configured with a feed of another fluid, for example in order to thus produce the corresponding mixture of fluids for the first temperature-control fluid 14 and/or the other temperature-control fluid 19.

It is indicated (in dashed lines) in FIG. 2 that the temperature-control device 6 may have not only two arrangements 12, 17 with discharge elements 13, 18, but that also a third arrangement 22 with a third discharge element 23 for a third temperature-control fluid 24 and/or generally other arrangements with discharge elements for a temperature-control fluid may be arranged. This/These arrangement(s) may be configured according to the remarks above, so that the remarks made in these contexts may be transferred also to these other arrangements of discharge elements. Also the other arrangements may preferably (each) be equipped with separate supply devices, which are independent of the other supply devices 16, 21.

Each arrangement of discharge elements of the temperature-control device 6 may form an independent unit inside the temperature-control device 6.

The number of discharge elements per arrangement may be the same in all arrangements. Yet, the different arrangements may also have a different number of discharge elements, so that the arrangements of discharge elements have different lengths in the conveying direction 3, for example.

FIG. 3 shows a schematic representation of a preferred and optionally independent embodiment variant of the temperature-control device 6, wherein the same reference numbers and/or the same component designations as in the preceding FIGS. 1 and 2 are used again for the same parts. To avoid unnecessary repetitions, the detailed description in relation to FIGS. 1 and 2 should be noted and/or is referred to. It should additionally be noted that this preferred embodiment variant according to FIG. 3 combines multiple embodiment variants of the invention, each of which may form independent embodiment variants.

It should further be noted that, in case of more than two arrangements 12, 17 of discharge elements 13, 18 these additional arrangements 22 may have the same structure as the first and other arrangements 12, 17, so that the remarks below can be transferred and/or applied also to the additional arrangements 22.

In this embodiment variant of the temperature-control device 6, the first arrangement 12 with the first discharge elements 13 for the first temperature-control fluid 14 and subsequently, in the conveying direction 3, the other arrangement 17 with the other discharge elements for the other temperature-control fluid 19 are arranged again. As opposed to the embodiment variant described above, in which the first discharge elements 13 and the other discharge elements 18 are arranged only on one side of the component 2, i.e. only above (or only below) the component 2 and/or the conveying plane 4, in the embodiment variant according to FIG. 3, some of the first discharge elements 13 are arranged above the conveying plane 4 and others of the first discharge elements 13 below the conveying plane 4 and/or some of the other discharge elements 13 are arranged above the conveying plane 4 and others of the other discharge elements 13 below the conveying plane 4. The component 2 is therefore moved through between first discharge elements 13 and/or between other discharge elements 18, so that the first temperature-control fluid 14 is applied to the component 2 from above and below and/or bilaterally and/or the other temperature-control fluid 19 is applied to the component 2 from above and below and/or bilaterally.

The number of first discharge elements 13 that are arranged above the conveying plane 4 may be smaller or greater or preferably equal to the number of first discharge elements 13 that are arranged below the conveying plane 4. Both the first discharge elements 13 arranged above the conveying plane 4 and the first discharge elements 13 arranged below the conveying plane 4 may be arranged in/at an encasement. In this context, reference is made to the remarks made above in relation to the housing 15.

The number of other discharge elements 18 that are arranged above the conveying plane 4 may be smaller or greater or preferably equal to the number of other discharge elements 18 that are arranged below the conveying plane 4. Both the first discharge elements 18 arranged above the conveying plane 4 and the other discharge elements 13 arranged below the conveying plane 4 may be arranged in/at an encasement. In this context, reference is made to the remarks made above in relation to the housing 20.

After exiting the first and other discharge elements 13, 18, the first and other temperature-control fluids 14, 19 flow onto the component 2 in order to effect a temperature control here.

It should be noted in this context that temperature control within the scope of the invention is understood to mean a cooling down and/or a heating and/or a maintaining of the temperature and/or of the temperature level of the component 2.

After the first and other temperature-control fluids 14, 19 have been applied to the component 2, the first and other temperature-control fluids 14, 19 can flow off into the surroundings. According to preferred embodiment variants of the temperature-control device 6, however, it may be provided that at least one receiving opening 25 of a first receiving device 26 for receiving the first temperature-control fluid 14 is arranged in the region of the first discharge elements 13 for the first temperature-control fluid 14, and/or that at least one receiving opening 27 of another receiving device 28 for receiving the other temperature-control fluid 19 is arranged in the region of the other discharge elements 18 for the other temperature-control fluid 19. The first temperature-control fluid 14 can flow and/or be sucked (off) into the first receiving device 26, for example a collector duct and/or a corresponding pipe, through this at least one first receiving opening 25 and/or the other temperature-control fluid 19 can flow and/or be sucked (off) into the other receiving device 28, for example a collector duct and/or a corresponding pipe, through this at least one other receiving opening 27. This enables a safe disposal of the first temperature-control fluid 14 and/or the other temperature-control fluid 19.

One or multiple first and/or other receiving openings 25, 27 may be provided. For example, first receiving openings 25 may be arranged and/or configured between each of the first discharge elements 13 or between groups of first discharge elements 13 and/or other receiving openings 27 may be arranged and/or configured between each of the other discharge elements 18 or between groups of other discharge elements 18.

In the embodiment variant of the temperature-control device 6 represented in FIG. 3, a first/first receiving opening(s) 25 may be arranged and/or configured both in the region of the first discharge elements 13 arranged above and in the region of the first discharge elements 13 arranged below the conveying plane 4 and/or another/other receiving opening(s) 27 may be arranged and/or configured both in the region of the other discharge elements 18 arranged above and in the region of the other discharge elements 18 arranged below the conveying plane 4.

Within the scope of the invention, the term “receiving opening” is to be understood broader, so that such receiving openings therefore also occur due to the distance between discharge elements.

To suck in and/or suck off the first and/or other temperature-control fluid 14, 19 a corresponding/corresponding extraction device(s), such as pumps, fans, etc., for example, may be provided in the temperature-control device 6.

Instead of disposing of the first and/or of the other temperature-control fluid 14, 19, the first and/or the other temperature-control fluid 14, 19 may be circulated. Optionally, they may also be prepared (purified), etc. To circulate them, the temperature-control device 6 may have a first temperature-control fluid circuit 29 for the first temperature-control fluid 14 and/or another temperature-control fluid circuit 30 for the other temperature-control fluid 19. The first and the other temperature-control fluid circuit 29, 30 may be formed with corresponding pipes.

The first discharge elements 13 and the first receiving device 26 may be integrated in the first temperature-control fluid circuit 29. The other discharge elements 19 and the other receiving device 28 may be integrated in the other temperature-control fluid circuit 30.

The temperature-control device 6 may have at least one first heat exchanger 31 and/or at least one other heat exchanger 32. The first heat exchanger 31 is provided for the first temperature-control fluid 14 and may be flow-connected to the first receiving device 26. Preferably, the first heat exchanger 31 is integrated in the first temperature-control fluid circuit 29. The other heat exchanger 32 is provided for the other temperature-control fluid 19 and may be flow-connected to the other receiving device 28. Preferably, the other heat exchanger 32 is integrated in the other temperature-control fluid circuit 30.

The first heat exchanger 31 serves to cool the first temperature-control fluid 14 and/or to adjust the first temperature-control fluid 14 to a specific temperature after the first temperature-control fluid 14 was applied to the component 2 and absorbed thermal energy in this process. This thermal energy may be transferred to a heat exchanger medium, e.g. water, in the first heat exchanger 31. To that end, the heat exchanger medium flows into the first heat exchanger 31 through a first inlet 33 and out of the first heat exchanger 31 through a first outlet 34. Instead of water, also another heat exchanger medium can be used.

The cooled down/temperature-controlled first temperature-control fluid 14 may be supplied to the first discharge elements 13 again. To that end, a conveying device, e.g. a first aspirator 35 or a pump, etc., may be arranged in the first temperature-control fluid circuit 29, in particular adjoining the first heat exchanger 31. If the first discharge elements 13 are divided up into first discharge elements 13 located above and first discharge elements 13 located below the conveying plane 4, a first branch-off 36 may be arranged in the first temperature-control fluid circuit 29, with which first branch-off 36 the first temperature-control fluid 14 can be distributed over the corresponding first discharge elements 13.

The first heat exchanger 31 may be a cross-flow heat exchanger or a counterflow heat exchanger or a parallel flow heat exchanger, for example. In particular, the first heat exchanger 31 is a gas-liquid heat exchanger. The first heat exchanger 31 may be configured according to the prior art. The first heat exchanger 31 may be a tube or flat tube heat exchanger.

Corresponding measuring devices, such as a temperature sensor 37, a pressure sensor, etc., for example, may also be arranged in the first temperature-control fluid circuit 29.

The other heat exchanger 32 serves to cool or heat the other temperature-control fluid 19 and/or to adjust the first temperature-control fluid 14 to a specific temperature after the first temperature-control fluid 14 was applied to the component 2. Thermal energy can be transferred to a heat exchanger medium, e.g. water, or absorbed by a heat exchanger medium, e.g. water, using the other heat exchanger 32. To that end, the heat exchanger medium flows into the other heat exchanger 32 through another inlet 38 and out of the first heat exchanger 31 through another outlet 39. Instead of water, also another heat exchanger medium can be used.

The cooled down/temperature-controlled other temperature-control fluid 19 may be supplied to the other discharge elements 18 again. To that end, a conveying device, e.g. another aspirator 40 or a pump, etc., may be arranged in the other temperature-control fluid circuit 30, in particular adjoining the other heat exchanger 32. If the other discharge elements 18 are divided up into first discharge elements 18 located above and other discharge elements 18 located below the conveying plane 4, another branch-off 41 may be arranged in the other temperature-control fluid circuit 30, with which other branch-off 41 the other temperature-control fluid 19 can be distributed over the corresponding other discharge elements 13.

The other heat exchanger 32 may be a cross-flow heat exchanger or a counterflow heat exchanger or a parallel flow heat exchanger, for example. In particular, the other heat exchanger 32 is a gas-liquid heat exchanger. The other heat exchanger 32 may be configured according to the prior art. The other heat exchanger 31 may be a tube or flat tube heat exchanger.

Corresponding measuring devices, such as a temperature sensor 42, a pressure sensor, etc., for example, may also be arranged in the other temperature-control fluid circuit 30.

The measuring devices and/or measuring instruments of the temperature-control device 6 may be used for controlling the temperature-control device 6 in an open loop and/or in a closed loop. According to an embodiment variant of the temperature-control device 6, it may be provided to that end that the temperature-control device 6 has an open-loop and/or closed-loop control device 43. The open-loop and/or closed-loop control device 43 may have a wireless or wired connection to the structural elements of the temperature-control device 6 that are controllable accordingly in an open loop or in a closed loop.

For example, it is possible according to an embodiment variant that the first and/or other discharge elements 13, 18 are controllable, individually or in groups, in an open loop and/or in a closed loop by the open-loop and/or closed-loop control device 43. What is meant here is that the volume flow of first temperature-control fluid 14 may be controlled in an open loop and/or in a closed loop by the first discharge elements 13 and/or the volume flow of other temperature-control fluid 19 may be controlled in an open loop and/or in a closed loop by the other discharge elements 18. For example, also the volume flow of first temperature-control fluid 14 may be adjusted accordingly, for example adjusted differently, to the first discharge elements 13 arranged above and below the conveying plane 4. The same applies to the other discharge elements 18.

To adjust the volume flow of first temperature-control fluid 14 by the first discharge elements 13 and/or of other temperature-control fluid 19 by the other discharge elements 18, the first discharge elements 13 may be assigned first cover elements 44 and the other discharge elements 18 may be assigned other cover elements 45, using which the size of the exit opening of the first and/or other discharge elements 13, 18 can be modified. It is thus also possible to adjust individual first and/or other discharge elements 13, 19 to fully inactive, i.e. to not just modify the cross section of the outflow opening of the first and/or other discharge elements 13, 18. Here, the first and other cover elements 44, 45 can be inserted between the first and/or other discharge elements 13, 18 and the component 2. The first and other cover elements 44, 45 may be configured as flaps, pushers, etc., for example. For further details in this context, reference is made to the aforementioned WO 2018/103841 A1 (which is incorporated in the present description in this scope).

To modify the volume flow of first and/or other temperature-control fluid 14, 19, also the rpm of the first aspirator 35 and/or generally of the conveying device for the first temperature-control fluid 13, and/or the rpm of the other aspirator 40 and/or generally of the conveying device for the other temperature-control fluid 19 may be controlled accordingly in an open loop and/or in a closed loop.

It may further be provided that the distance between the first and/or other discharge elements 13, 18 and the component 2 is modified by the first and/or other discharge elements 13, 18 being placed closer to the component 2 or removed further from the component 2. To that end, the temperature-control device 6 may have corresponding linear adjustment devices for the first and/or other discharge elements 13, 18.

As explained in the introduction, the temperature-control device 6 may be operated with differently composed temperature-control fluids 14, 19. This is to achieve, for example, that the first temperature-control fluid 14 and the other temperature-control fluid 19 have different thermal capacities, which enables an influence on the temperature control of the component 2 and/or on the entire temperature-control process that the component 2 undergoes in the temperature-control device 6. Also in this region, an open-loop and/or closed-loop control is possible, by setting and/or adjusting the concentrations of the components of the first and/or other temperature-control fluid 14, 19 accordingly. For example, a feed 46 (a bypass line) may be provided in the supply of the other temperature-control fluid 19 to that end, with which feed 46 a component (e.g. hydrogen) of the other temperature-control fluid 19 is mixed with another component (e.g. nitrogen), so that the other temperature-control fluid 19 consists of a mixture of at least two components. The same may also be provided in the supply of the first temperature-control fluid 14 to the first discharge elements 13.

It should be mentioned in this context for the sake of completeness that a supply of first and/or other temperature-control fluid 14, 19 may be provided in the first and/or other temperature-control fluid circuit 29, 30 as needed in order to thus be able to compensate for lost volumes of first and/or other temperature-control fluid 14, 19 if a 100% circulation of the first and/or other temperature-control fluid 14, 19 is not possible.

Depending on the execution of the process, an increase of the temperature of the component 2 may be provided after the first cooling down of the component 2 with the first temperature-control fluid 14. To that end, the other heat exchanger 32 can be used to increase the temperature of the other temperature-control fluid 19 accordingly.

Alternatively or additionally, it may also be provided that a heating device 47, for example an electrical heating device 47, is provided for at least some of the other temperature-control fluid 19. The heating device may be provided in the supply of the other component of the other temperature-control fluid 19, for example. Yet, the heating device 47 may also be arranged at a different location in the other temperature-control fluid circuit 30. The heating device 47 can be used to heat the other temperature-control fluid 19, for example from 20° C. to up to 600° C.

Also in the first temperature-control fluid circuit 29 and/or in the supply of the first temperature-control fluid 14 to the first discharge elements 13, such a heating device for heating the first temperature-control fluid 14 may be arranged as needed, for example in order to adjust to a smaller cool-down gradient.

FIG. 4 shows a detail from an embodiment variant of the temperature-control device 6. Represented are the first and other discharge elements 13, 18, which are distributed over two planes again as explained above, so that the first and the other temperature-control fluid 14, 19 can be applied to the component 2 (see FIG. 3) from above and from below (see FIG. 3). Some of the first and other discharge elements 13, 18 are arranged so as to extend diagonally in order to thus create space between the first and other discharge elements 13, 18 for sucking off the first and other temperature-control fluids 14, 19. The first and other discharge elements 14, 19 themselves are configured as wide-slot nozzles.

In this embodiment variant, the first discharge elements 13 are distributed over multiple first segments 48, wherein each of the first segments 48 respectively has a separate supply 49 for the first temperature-control fluid 14 and/or the other discharge elements 18 are distributed over multiple other segments 50, wherein each of the other segments 50 respectively has a separate supply 51 for the other temperature-control fluid 19.

The temperature-control device 9 and/or the plant 1 can be used to heat-treat the most varied metals. For example, the temperature-control device 9 and/or the plant 1 can be used to subject steel to an austenitizing process in the furnace 5. To that end, the component 2 can be maintained at the so-called austenitizing temperature for at least 2 seconds, for example between 2 seconds and 2 hours or between 2 seconds and 30 minutes. The austenitizing process and/or the austenitizing temperature as such are known from the prior art, so that reference is hereby made to them. Depending on the temperature control in the temperature-control device 6, a martensitic, a bainitic, a sorbitic and/or a mixed microstructure can then be adjusted. Several possible executions of the process are specified below, wherein the temperatures in the component 2 are adjusted using the first and the other temperature-control fluid 14, 19. It is of advantage here that the first and the other temperature-control fluid 14, 19 have different compositions and/or can be used in different temperature-control fluid circuits 29, 30.
Martensite: rapid quenching to 280° C.-200° C. with a cool-down speed of at least 50 K/s, for example between 50 K/s and 300 K/s, subsequently short homogenization, e.g. between 5 seconds to 80 seconds, finishing cooling, transformation of the microstructure,
bainite: rapid quenching to 450° C.-380° C. with a cool-down speed of at least 50 K/s, for example between 50 K/s and 300 K/s, subsequent homogenization, e.g. between 30 seconds to 90 seconds, maintaining,
sorbite: rapid quenching to 550° C.-480° C. with a cool-down speed of at least 50 K/s, for example between 50 K/s and 300 K/s, subsequent homogenization, e.g. between 5 seconds to 180 seconds, maintaining, reheating, transformation of the microstructure, finishing cooling,
CrM: controlled quenching to 290° C.-200° C. with a cool-down speed of at least 20 K/s, for example between 20 K/s and 200 K/s, subsequently homogenization, e.g. between 5 seconds to 80 seconds, and finishing cooling, normalizing: slow cooling down, wherein a specific gradient must not be exceeded (e.g. 25 K/s).

The exemplary embodiments show and/or describe possible embodiment variants of the temperature-control device 6 and/or the plant 1, wherein it should be noted in this context that also combinations of the individual embodiment variants are possible.

Finally, as a matter of form, it should be noted that for ease of understanding of the structure of the temperature-control device 6 and/or the plant 1, these are not necessarily depicted to scale.

Table of reference numbers

| | |
|---|---|
| 1 | plant |
| 2 | component |
| 3 | conveying direction |
| 4 | conveying plane |
| 5 | furnace |
| 6 | temperature-control device |
| 7 | conveying device |
| 8 | furnace inlet |
| 9 | furnace outlet |
| 10 | device inlet |
| 11 | device outlet |
| 12 | arrangement |
| 13 | discharge element |
| 14 | temperature-control fluid |
| 15 | housing |
| 16 | supply device |
| 17 | arrangement |
| 18 | discharge element |
| 19 | temperature-control fluid |
| 20 | housing |
| 21 | supply device |
| 22 | arrangement |
| 23 | discharge element |
| 24 | temperature-control fluid |
| 25 | receiving opening |
| 26 | receiving device |
| 27 | receiving opening |
| 28 | receiving device |
| 29 | temperature-control fluid circuit |
| 30 | temperature-control fluid circuit |
| 31 | heat exchanger |
| 32 | heat exchanger |
| 33 | inlet |
| 34 | outlet |
| 35 | aspirator |
| 36 | branch-off |
| 37 | temperature sensor |
| 38 | inlet |
| 39 | outlet |
| 40 | aspirator |
| 41 | branch-off |
| 42 | temperature sensor |
| 43 | closed-loop control device |
| 44 | cover element |
| 45 | cover element |
| 46 | feed |
| 47 | heating device |
| 48 | segment |
| 49 | supply |
| 50 | segment |
| 51 | supply |

1. A temperature-control device (6) for controlling the temperature of a component (2), which is transported through the device in a conveying direction (3) along at least one conveying plane (4), the temperature-control device (6) comprising a first arrangement (12) of first discharge elements (13) for supplying a first, in particular gaseous, temperature-control medium (14) to the component (2), and at least one other arrangement (17) of other discharge elements (18) downstream of the first arrangement (12) of first discharge elements (13) in the conveying direction (3), wherein a first receiving opening (25) of a first receiving device (26) for receiving the first temperature-control fluid (14) is arranged in the region of the first discharge elements (13) for the first temperature-control fluid (14), and the first receiving device (26) is flow-connected to at least one first heat exchanger (29), wherein the first discharge elements (13), the first receiving device (26) and the first heat exchanger (30) are arranged in a first temperature-control fluid circuit (29), wherein multiple first receiving openings (25) are arranged between the first discharge elements (13), wherein, further, the other discharge elements (18) are configured for supplying at least one other, in particular gaseous, temperature-control medium (19) to the component (2), wherein multiple other receiving openings (27) of another receiving device (28) for receiving the other temperature-control fluid (19) are arranged in the region of the other discharge elements (18) for the other temperature-control fluid (19), wherein the other receiving device (28) is flow-connected to at least one other heat exchanger (32), and wherein the other discharge elements (18), the other receiving device (28) and the other heat exchanger (32) are arranged in another temperature-control fluid circuit (30).

2. The temperature-control device (6) according to claim 1, wherein some of the first discharge elements (13) are arranged above the conveying plane (4) and others of the first discharge elements (13) are arranged below the conveying plane (4).

3. The temperature-control device (6) according to claim 1, wherein some of the other discharge elements (18) are arranged above the conveying plane (4) and others of the other discharge elements (18) are arranged below the conveying plane (4).

4. The temperature-control device (6) according to claim 1, wherein the first and/or other discharge elements (13, 18) are controllable, individually or in groups, in an open loop and/or in a closed loop by an open-loop and/or closed-loop control device (43).

5. The temperature-control device (6) according to claim 4, wherein the open-loop and/or closed-loop control device (43) is configured for controlling, in an open loop and/or in a closed loop, at least one of the following parameters for supplying the first temperature-control fluid (14) to the first discharge elements (13) and/or the other temperature-control fluid (19) to the other discharge elements (18):
the volume flow of the first temperature-control fluid (14) and/or of the other temperature-control fluid (19);
the composition of the first temperature-control fluid (14) and/or of the other temperature-control fluid (19);
a first distance of the first discharge elements (13) to the conveying plane (4) and/or another distance of the other discharge elements (18) to the conveying plane (4);
the number of active first discharge elements (13) and/or active other discharge elements (18).

6-13. (canceled)

14. The temperature-control device (6) according to claim 1, wherein a heating device (47) for heating at least some of the other temperature-control fluid (19) is arranged upstream of the other discharge elements (18) in a flow direction of the other temperature-control fluid (19).

15. The temperature-control device (6) according to claim 1, wherein the first discharge elements (13) are distributed over multiple first segments (48), wherein each of the first segments (48) respectively has a separate supply (49) for the first temperature-control fluid (14) and/or wherein the other discharge elements (18) are distributed over multiple other segments (50), wherein each of the other segments (50) respectively has a separate supply (51) for the other temperature-control fluid (19).

16. A plant (1) for adjusting a microstructure or a microstructure distribution in a metal component (2) comprising a furnace (5) for heating the metal component (2) to a first temperature and a temperature-control device (6) for controlling the temperature of the component (2) to at least one second temperature, which is lower than the first temperature, wherein the temperature-control device (6) is configured according to claim 1.

17. A method for adjusting a microstructure or a microstructure distribution in a metal component (2) comprising the steps:
heating the component (2) to a first temperature in a furnace (5),
cooling down the heated component (2) to a second temperature, which is lower than said first temperature, in a temperature-control device (6), to which end a first temperature-control fluid (14), which is discharged from first discharge elements (13), is applied to the component (2) in the temperature-control device (6),
wherein a first receiving opening (25) of a first receiving device (26) for receiving the first temperature-control fluid (14) is arranged in the region of the first discharge elements (13) for the first temperature-control fluid (14), and the first receiving device (26) is flow-connected to at least one first heat exchanger (29), wherein the first discharge elements (13), the first receiving device (26) and the first heat exchanger (30) are arranged in a first temperature-control fluid circuit (29),
wherein the first temperature-control fluid (14) is received between the first discharge elements (13) through multiple first receiving openings (25), wherein, after the treatment with the first temperature-control fluid (14), another temperature-control fluid (19), which is discharged from other discharge elements (18), is applied to the component (2) in the temperature-control device (6), wherein multiple other receiving openings (27) of another receiving device (28) for receiving the other temperature-control fluid (19) are arranged in the region of the other discharge elements (18) for the other temperature-control fluid (19), wherein the other receiving device (28) is flow-connected to at least one other heat exchanger (32), and wherein the other discharge elements (18), the other receiving device (28) and the other heat exchanger (32) are arranged in another temperature-control fluid circuit (30).

18. The method according to claim 17, wherein, after the cooling down of the component (2) with the first temperature-control fluid (14), an increase of the temperature of the component (2) is executed with the other temperature-control fluid (19).

19. The method according to claim 17, wherein the component (2) is heated to austenitizing temperature as a first temperature in a furnace (5) for at least 2 seconds and is subsequently
quenched to 280° C.-200° C. with at least 50 K/s for forming a martensitic microstructure and is preferably subsequently homogenized and finishing cooled, or
is quenched to 450° C.-380° C. with at least 50 K/s for forming a bainitic microstructure and is preferably subsequently homogenized in a time between 30 seconds to 90 seconds and maintained at the temperature, or
is quenched to 550° C.-480° C. with at least 50 K/s for forming a sorbitic microstructure and is preferably subsequently homogenized in a time between 5 seconds to 10 seconds, maintained at the temperature, reheated and finishing cooled, or
is quenched to 290° C.-200° C. with at least 20 K/s for forming a martensitic microstructure in a chromic steel and is preferably subsequently homogenized and finishing cooled, or
is cooled down with a cool-down speed of maximal 30 K/s, in particular maximal 25 K/s, to the second temperature for normalizing.

20. The method according to claim 17, wherein the component (2) is brought from the furnace (5) directly into the temperature-control device (6).

21. The method according to claim 17, wherein a gaseous or vaporous fluid, in particular hydrogen or nitrogen or a mixture thereof, is used as the first temperature-control fluid (14) and/or as the other temperature-control fluid (19).

22. The method according to claim 17, wherein a fluid that is different from the first temperature-control fluid (14), in particular has a different thermal capacity, is used as the other temperature-control fluid (19).

23. The method according to claim 17, wherein the component (2) is moved through between first discharge elements (13) and/or between other discharge elements (18), so that the first temperature-control fluid (14) is applied to the component (2) bilaterally and/or the other temperature-control fluid (19) is applied to the component (2) bilaterally.
